(19) United States
(12) Patent Application Publication
(10) Pub. No.: US 2019/0128794 A1
(43) Pub. Date: May 2, 2019

(54) CORROSION SENSOR AND METHOD FOR MONITORING THE CONDITION OF A THERMALLY INSULATED STRUCTURE

(71) Applicant: PAROC GROUP OY, Helsinki (FI)

(72) Inventors: Jari Rehu, Espoo (FI); Timo Saario, Espoo (FI); Seppo Peltonen, Espoo (US)

(21) Appl. No.: 16/301,474

(22) PCT Filed: Apr. 11, 2017
(86) PCT No.: PCT/FI2017/050262

§ 371 Date: Nov. 14, 2018

(30) Foreign Application Priority Data
May 20, 2016 (FI) 20165424

(51) Int. Cl. G01N 17/04

(52) U.S. Cl. CPC G01N 17/043

(57) ABSTRACT

The invention relates to a corrosion sensor (1) to be used on the surface of a corrosion piece of a substantially metal material, such as a metal pipe or metal sheet, to indicate the corrosion degree and corrosion speed, the corrosion sensor (1) having detection elements, which are manufactured substantially from iron, and the corrosion sensor having connection sites associated with the detection elements for the measurement means. The corrosion sensor (1) has, in the detection elements, at least two shoulders (2-4), each having a different thickness; and at least one external resistance (6-8). The invention further relates to a method for monitoring the condition of a thermally insulated structure.

The present invention relates to a corrosion sensor to be used on the surface of a corrosion piece for indicating the corrosion degree and corrosion speed, the corrosion sensor having detection elements, which are manufactured substantially from iron, and the corrosion sensor having two connection sites associated with the detection elements for the measurement means, as well as a method for monitoring the condition of a thermally insulated structure.

Corrosion is a problem in various places and, particularly, observing corrosion occurring in the insulated structures of the process industry, such as in pipelines, is difficult and typically requires dismantling insulations in order to inspect the state of their underlying structure. Such an inspection work is slow and labour-intensive, creating significant expenses. In addition, for example, in the case of long pipelines, it is, in practice, not appropriate to dismantle insulations along the entire length of the pipeline, but instead from sites estimated in advance as the most high-risk. In this case, there is a risk that corrosion is able to progress unnoticed at uninspected sites. As a further problem, the process industry has energy losses via non-insulated sites, such as the valves and flange connections of the pipelines, the observing of whose leaks cannot easily be implemented, if the sites in question are underneath insulation.

The present invention relates to improving the observation of corrosion by developing a corrosion sensor, which is relatively simple, mechanically resistant and structurally reliable and which is to be disposed within the insulation onto the surface of a object or in the vicinity of the surface such that the sensor is exposed to the same conditions as the object to be measured. The objective is to provide a corrosion sensor, which indicates the presence of corrosion and, further, also the progression speed of the corrosion. In addition, the objective of the invention is to provide a method, which can be used to inspect, in addition to the erosion of insulated structures, also their leaks and thermal insulation capacity especially at the valves, flanges and equivalents of the process industry.

In order to achieve this objective, a corrosion sensor according to the invention is characterized in that the corrosion sensor has
in the detection elements at least two shoulders, each having a different thickness; and
at least one external resistance.

The detection elements preferably comprise three shoulders, the thicknesses of which are selected, for example, to the values of 20 μm, 50 μm and 100 μm. Each shoulder will break down when it has been completely consumed by corrosion. As one shoulder breaks down, the signal level increases in a bounce.

A method for monitoring the condition of a thermally insulated structure according to the invention is characterized by that, which is presented in the characterizing part of independent claim 5.

In the following, the invention is described by means of reference to the accompanying figures, in which:

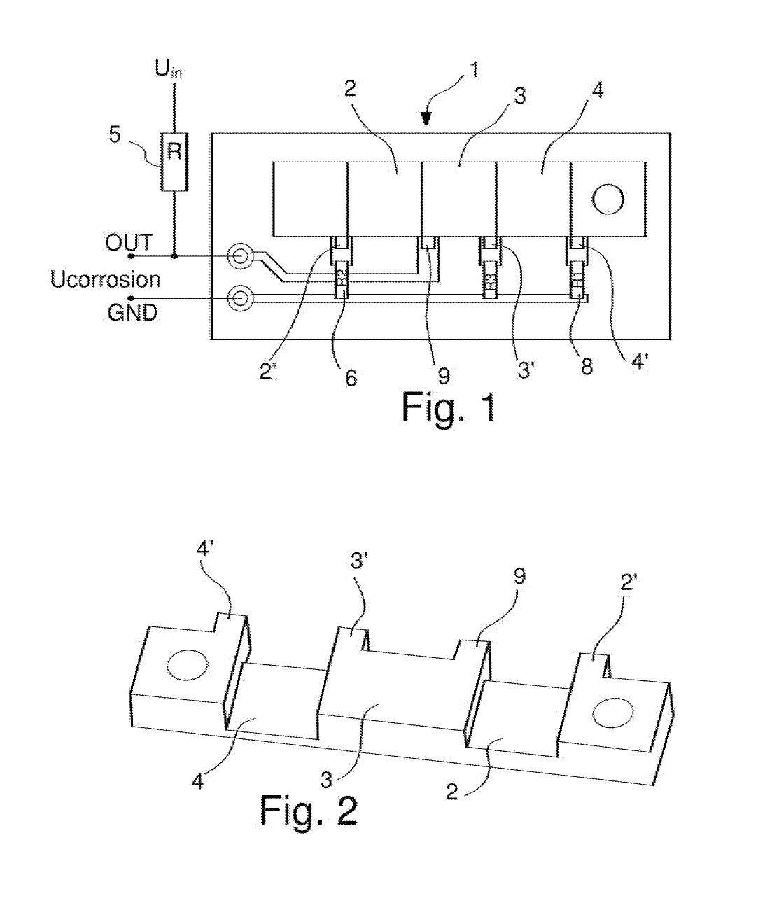

FIG. 1 shows diagrammatically one embodiment of a corrosion sensor according to the invention,

FIG. 2 shows a part of the sensor of FIG. 1 as an isometric view,

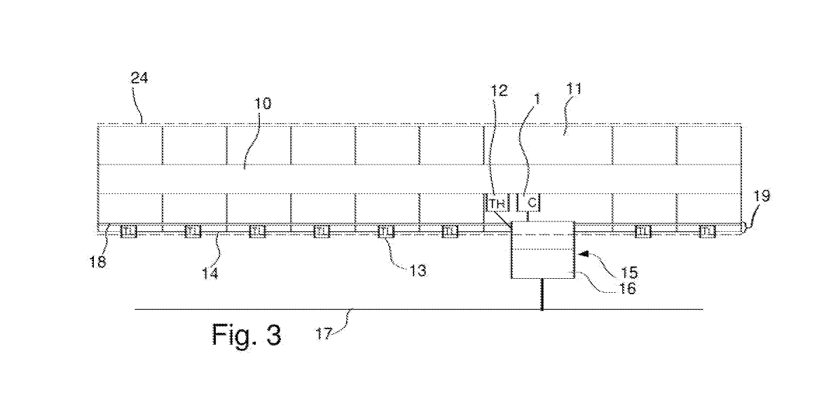

FIG. 3 shows a diagrammatic principle illustration of one embodiment of a measurement arrangement utilizing a corrosion sensor according to the invention in connection with a thermally insulated pipe,

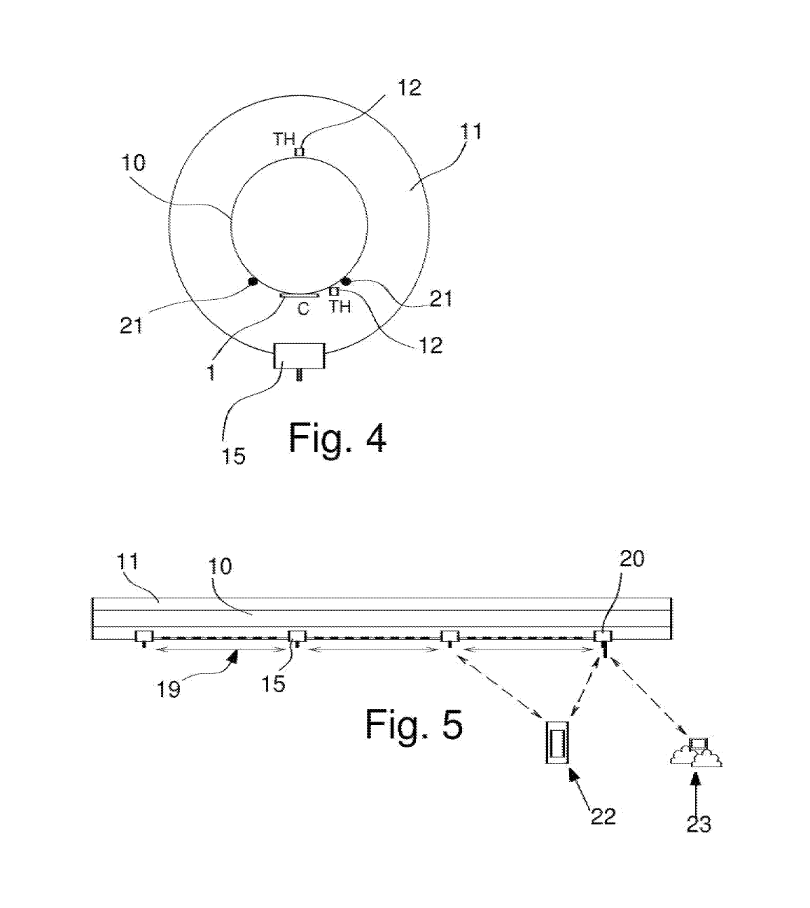

FIG. 4 shows the placement of the sensors around a pipe in cross-section as a diagrammatic example,

FIG. 5 shows a diagrammatic principle illustration of the data transmission arrangement in connection with the measurement arrangement,

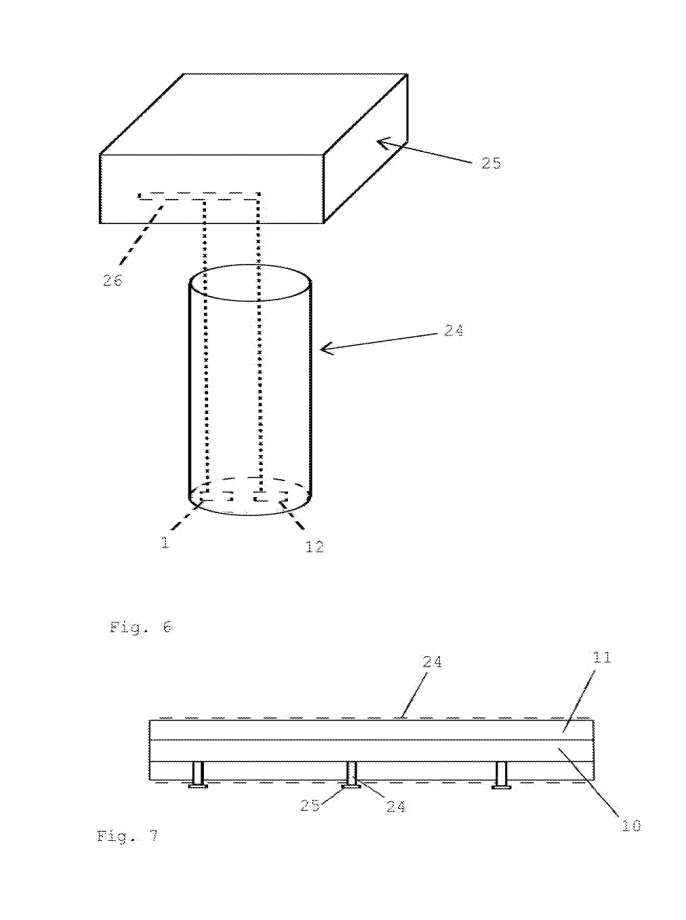

FIG. 6 shows a diagrammatic principle illustration of one installation manner of the sensors, and

FIG. 7 shows installations of the sensors of FIG. 6 disposed onto the lower surface of a pipeline.

FIGS. 1 and 2 show a diagrammatic principle illustration of one embodiment of a corrosion sensor 1 according to the invention. The corrosion sensor 1 has a detection element arranged onto a printed circuit board, which detection element has erodible shoulders 2, 3 and 4 with three different thicknesses, these thicknesses being respectively 50 μm, 100 μm and 20 μm. The shoulders 2-4 have preferably the thickness in the range of 10-30 μm, 40-60 μm and 90-110 μm, more preferably 15-25 μm, 45-55 μm and 95-105 μm, and yet more preferably 19-21 μm, 49-51 μm and 99-101 μm. The material of the detection element is preferably iron. Each shoulder 2-4 is connected from the coupling point 2′-4′ though a corresponding external resistance 6-8 to the ground, wherein resistances are coupled in parallel. In this exemplary case, the resistances are selected as follows: the 20 μm shoulder is connected to the resistance 8 (R1) of 100Ω, the 50 μm is connected to the resistance 6 (R2) of 200Ω and the 100 μm shoulder is connected to the resistance 7 (R3) of 400Ω. In a measurement situation, for example, 3 V DC voltage Uin is fed through the series resistor 5 (R) of 200Ω into the coupling point 9. The signal Ucorrosion to be measured from the sensor changes as a result of a change in the resistance of the load the sensor comprises. Examined ideally, the total resistance of the resistances 6-8 coupled in parallel is Rtot=1/[(1/R1+1/R2+1/R3)], where R1, R2 and R3 are unequal. The assumption is that the first to erode will be the thinnest, the 20 μm shoulder, wherein coupled with the resistance 8 (R1) into a series remains ideally an open circuit, wherein R1 no longer influences the total resistance. In that case, there remains resistances 6 and 7, and the total resistance is Rtot=1/[(1/R2+1/R3)]. If the 50 μm shoulder further erodes through, then there remains only resistance Rtot=R3, through which current travels. If this too should erode through, then the resistance would increase, in theory, infinitely and, in practice, so greatly that current would not travel. In this case, the measured voltage is the supply voltage Uin.

The practical implementation obtains substantially corresponding results as with the ideal inspection.

The voltage Ucorrosion measured in the presented exemplary implementation is initially 0.7 V, from which it can rise to the level of 1.2 V, 2.0 V and 3.0 V as the shoulders with thicknesses of 20 μm, 50 μm and 100 μm break down in this order. By using unequal resistances in connection with the shoulders, the order in which the shoulders break can be discovered, which generally is from the thinnest to the thickest. In this case, the corrosion progression speed can also be discovered. For example, when the measured voltage Ucorrosion is 0.7 V, there is no corrosion or its amount is less than 20 μm. When the measured voltage Ucorrosion rises to 1.2 V, corrosion has progressed to the range between 20 μm and 50 μm and, at voltage value Ucorrosion=2.0 V, corrosion has progressed to the range of 50-100 μm, and so on so forth. By taking into consideration the time at which each measurement was made, it is possible to estimate, at what speed corrosion is progressing at each measurement point.

The received data provided by the corrosion sensor can be utilized, for example, such that when one of the shoulders of the sensor erodes through, the signal (voltage level Ucorrosion) of the corrosion sensor rises to some of the pre-known levels, and the changed signal level triggers the pre-programmed alarm function of a diagnostic/analytics tool. The alarm function can be, for example, bringing the corrosion signal into view in the meters of the user interface and the transmission of an alarm message to a pre-defined address, for example, by electronic mail, as an SMS message or by some other manner. Each corrosion sensor is preferably given a unique identifier and its location is assigned to the diagnostics/analytics tool. In this case, when an alarm arrives, it is known both the corrosion level and the site where the corrosion was observed. The alarm message can cause either an inspection measure to be performed on-site, or as needed, the closing of the pipeline for repair measures. The alarm message can also just be acknowledged as received and one can remain waiting for the next corrosion signal before any other measures.

FIG. 3 illustrates the pipeline condition measurement system, which utilizes a corrosion sensor according to the invention. The corrosion sensor 1 is disposed onto the outer surface of the pipe 10 within the insulation 11 surrounding the pipe. The corrosion sensor can be attached, for example, by means of an attachment band surrounding the pipe. The corrosion sensor 1 is connected to the measurement unit 15, which is connected through the connection 16 into the automation bus 17. In the shown embodiment, to the measurement unit 15 are further connected the high temperature TH sensor 12 and the low temperature TL sensors 13. The low temperature sensors are preferably connected with a uniform sensor strip 19, in which TL sensors 13 are at approx. 1 m intervals and to which is further connected a permanent leak sensor 18 (L sensor). The length of such a sensor strip can be tens of metres. The sensor strip 19 is preferably installed between the outer surface of the insulation layer 11 and the coating protecting it. The coating is shown in FIG. 3 by dashed lines with reference numeral 24. The coating is typically of tin. The sensor strip 19 can be pre-integrated into the material forming the insulation layer, which is preferably of mineral wool. The mineral wool can be, for example, as sheet-like or trough-like elements. As the insulating material can be considered also other materials suitable for each application, such as polyurethane insulation. There can also be only one low temperature sensor per measurement unit. Likewise, there can be, instead of the permanent leak sensor presented above, one or more separate leak sensors.

The measurement units 15 are disposed preferably at approx. 10 m intervals onto a direct pipe and, further, in connection with the valves and/or flanges. Using the high temperature measurement, data about the surface temperature of the pipe is received with approx. 10 m accuracy and, using the low temperature measurement, data about the heat leakage of the insulation at approx. 1 m intervals.

Each sensor is given its own identifier (ID), which are encoded to the measurement unit 15.

FIG. 4 shows one placement example for the sensors as a cross-sectional view. The measurement points are preferably close to the bottom dead centre of the pipe and, likewise, the measurement unit 15 can be disposed below the pipe, wherein it is better protected and the antenna associated therewith is also protected. In order to monitor the function of the trace heating, for example, the electric cables 21 associated with the pipe, there is preferably a high temperature sensor 12 in the vicinity of the top dead centre of the pipe.

FIG. 5 shows diagrammatically an example of a data transmission arrangement in connection with the measurement arrangement. Preferably, data can be collected from the measurement units 15 by means of a mobile device 22 and/or data can be transferred wirelessly to a cloud server 23.

The measurement arrangement presented above can be particularly utilized at the valve casings and/or connection flanges in pipelines, wherein there can be discovered both the corrosion degree at the measurement site as well as possible fluid leaks and the condition of the thermal insulation. In a method according to the invention, the corrosion sensor 1 is installed onto the surface of an insulated structure or in its vicinity inside the insulation layer and connected to the measurement unit 15, to which is further connected a sensor strip 19 having several low temperature sensors 13 at a distance from each other, as well as a permanent leak sensor 18, the sensor strip 19 being installed onto the outer surface of the insulation layer between the insulation layer and the coating protecting it. In the method, high temperature sensors 12 are further disposed onto the surface of an insulated structure or in its vicinity inside the insulation layer and they are connected to the measurement unit 15. On the basis of the signal provided by the corrosion sensor 1, the corrosion degree and/or progression speed at the measurement site can be deduced and, on the basis of the data provided by the temperature sensors 12, 13, the condition of the thermal insulation can be deduced, i.e. heat leakages at the low temperature measurement sites. The signal provided by the leak sensor 18 indicates the occurrence of a possible leak. The leak sensor is preferably arranged to indicate, in addition to a leak, also the quality of the fluid that is leaking, for example, does the leak fluid contain hydrocarbons, or merely water. In this case, the leak sensor can be, for example, a capacitive sensor, with which is measured for the medium the dielectric constant, which has different values of for different mediums.

A solution according to the invention can also be implemented, for example, as a retrofitted package diagrammatically shown in FIG. 6, the package containing a cylindrical sensor box 24, inside which is arranged a corrosion sensor 1 and a high temperature sensor 12, to settle against an object to be measured or close to it. In connection with the sensor box, a measurement unit 25 is arranged before placing the sensor box into said hole or after the installation, the measurement unit containing the required measurement electronics, which are connected to the sensors of the sensor box 1, 12 by suitable conductors, which are preferably disposed within the protective material, which prevents their exposure to corrosive conditions. In practice, parts other than the detection elements of the corrosion sensor are protected in order that they would not be exposed to corrosion. In order to install the sensor box, into the insulation layer and into the possible protective plate is drilled a hole corresponding to the diameter of the sensor box, into which hole the sensor box is tightly disposed, the measurement unit remaining outside the protective plate. The sensor box has preferably also a low temperature sensor and/or leak sensor on the side of the outer surface of the insulation layer, or to the sensor box 24 or to the measurement unit 25 can be connected, for example, the sensor strip 19 presented above. FIG. 7 shows, as an example, the placement of three sensor boxes 24 and a measurement unit 25 onto the lower surface of a pipeline. The measurement units 25 are located outside the protective plate, providing the transmission of measurement data by radio link to a desired object. The distance between the sensor boxes/measurement units depends, i.a. on the desired resolution and the range of the wireless transmitters. It can be from a few metres to even more than one hundred metres.

### LIST OF REFERENCE NUMERALS

1 corrosion sensor
2-4 shoulder
2′-4′ coupling point
5-8 resistance
9 supply coupling point
10 pipe
11 insulation
12 high temperature sensor TH
13 low temperature sensor TL
14 local bus
15 measurement unit
16 connection to the automation bus
17 automation bus
18 leak sensor
19 sensor strip
20 transmission unit
21 pipe trace heating
22 mobile scanner device
23 cloud server
24 sensor box
25 measurement unit
26 measurement electronics

1-8. (canceled)

9. A corrosion sensor to be used on a surface of a metal material subject to corrosion, said corrosion sensor operable to indicate a corrosion degree and a corrosion speed of the material, said corrosion sensor comprising:
a first shoulder having a first thickness;
a second shoulder having a second thickness;
a third shoulder having a third thickness;
a first resistor having a first resistance;
a second resistor having a second resistance; and
a third resistor having a third resistance;
wherein the first thickness, the second thickness, and the third thickness all differ from one another;
wherein the first resistance, the second resistance, and the third resistance all differ from one another;
wherein the first shoulder is connected to the first resistor by a first serial connection;
wherein the second shoulder is connected to the second resistor by a second serial connection;
wherein the third shoulder is connected to the third resistor by a third serial connection;
wherein the first serial connection, the second serial connection, and the third serial connection are connected to one another in parallel to form a total resistance of R_{TOT}; and
wherein the total resistance R_{TOT} changes as each of the first shoulder, the second shoulder, and the third shoulder is broken,
whereby a voltage level U_{corrosion} generated by the corrosion sensor can be measured to determine the corrosion degree and the corrosion speed of the material.

10. The corrosion sensor of claim 9, wherein the material is part of a pipe.

11. The corrosion sensor of claim 9, wherein the first shoulder, the second shoulder, and the third shoulder are made from iron.

12. The corrosion sensor of claim 9, wherein the first thickness is in the range of 10-30 μm, the second thickness is in the range of 40-60 μm, and the third thickness is in the range of 90-110 μm.

13. The corrosion sensor of claim 12, wherein the first thickness is in the range of 15-25 μm, the second thickness is in the range of 45-55 μm, and the third thickness is in the range of 95-105 μm.

14. The corrosion sensor of claim 13, wherein the first thickness is in the range of 19-21 μm, the second thickness is in the range of 49-51 μm, and the third thickness is in the range of 99-101 μm.

15. The corrosion sensor of claim 9, wherein the first resistance is approximately 100Ω, the second resistance is approximately 200Ω, and the third resistance is approximately 400Ω.

16. The corrosion sensor of claim 9, further comprising an input voltage Uᵢₙ that is fed through a fourth resistor having a fourth resistance.

17. The corrosion sensor of claim 16, wherein the input voltage Uᵢₙ is approximately 3 V.

18. The corrosion sensor of claim 16, wherein the fourth resistance is approximately 200Ω.

19. The corrosion sensor of claim 9, wherein the first shoulder, the second shoulder, and the third shoulder are on a printed circuit board.

20. The corrosion sensor of claim 19, wherein the first resistor, the second resistor, and the third resistor are on the printed circuit board.

21. A method of monitoring the condition of a thermally insulated structure, the method comprising:
(a) installing a corrosion sensor on the structure below an insulation layer, said corrosion sensor comprising:
a first shoulder having a first thickness;
a second shoulder having a second thickness;
a third shoulder having a third thickness;
a first resistor having a first resistance;
a second resistor having a second resistance; and
a third resistor having a third resistance;
wherein the first thickness, the second thickness, and the third thickness all differ from one another;
wherein the first resistance, the second resistance, and the third resistance all differ from one another;
wherein the first shoulder is connected to the first resistor by a first serial connection;
wherein the second shoulder is connected to the second resistor by a second serial connection;
wherein the third shoulder is connected to the third resistor by a third serial connection;
wherein the first serial connection, the second serial connection, and the third serial connection are connected to one another in parallel to form a total resistance of R_{TOT}; and
wherein the total resistance R_{TOT} changes as each of the first shoulder, the second shoulder, and the third shoulder is broken;
(b) applying an input voltage Uᵢₙ to the corrosion sensor; and
(c) monitoring at least one of a corrosion degree and a corrosion speed of the structure by measuring a voltage level U_{corrosion} generated by the corrosion sensor.

22. The method of claim 21, wherein a plurality of the corrosion sensors are installed on the structure.

23. The method of claim 22, wherein the corrosion sensors are evenly spaced along the structure.

24. The method of claim 21, wherein the structure is a pipe.

25. The method of claim 21, wherein the corrosion sensor is installed on an outer surface of the structure or in proximity to the outer surface of the structure.

26. The method of claim 21, wherein the corrosion sensor is installed inside the insulation layer.

27. The method of claim 21, further comprising:
(d) connecting the corrosion sensor to a measurement unit; wherein the measurement unit is connected to a low temperature sensor and a high temperature sensor; wherein the low temperature sensor is positioned closer to an outer surface of the insulation layer than to an outer surface of the structure; and wherein the high temperature sensor is positioned closer to the outer surface of the structure than to the outer surface of the insulation layer; and
(e) monitoring a condition of the insulation layer based on data from the low temperature sensor and the high temperature sensor.

28. The method of claim 21, wherein the insulation layer is formed from mineral wool.
